(19) United States
(12) Patent Application Publication
(10) Pub. No.: US 2002/0049885 A1
(43) Pub. Date: Apr. 25, 2002

(54) PERSONAL COMPUTER WITH AN EXTERANL CACHE FOR FILE DEVICES

(76) Inventor: HIROSHI SUZUKI, YAMAGATA (JP)

Correspondence Address: SUGHRUE MION ZINN MACPEAK & SEAS, 2100 PENNSYLVANIA AVENUE NW, WASHINGTON, DC, 20037

(21) Appl. No.: 09/287,286

(22) Filed: Apr. 7, 1999

(30) Foreign Application Priority Data
Apr. 10, 1998 (JP) 10-098746

(51) Int. Cl. G06F 12/00

(52) U.S. Cl. 711/113; 711/168

(57) ABSTRACT

The personal computer with an external cache for file devices comprises a personal computer (1), a cache adapter (4) which is connected to the personal computer (1) through a primary IDE bus (2) and a secondary IDE bus (3), a cache memory (6) which is connected to the cache adapter (4) through a local bus (5), a primary master drive (9) and a primary slave drive (10) which are connected to the cache adapter (4) through a cached primary IDE bus (7), and a secondary master drive (11) and a secondary slave drive (12) which are connected to the cache adapter (4) through a cached secondary IDE bus (8).

### CROSS REFERENCE TO RELATED APPLICATIONS

The present invention claims priority from Japanese Patent Application No. 10-098746 filed Apr. 10, 1998, the contents of which are incorporated herein by reference.

### BACKGROUND OF THE INVENTION

1. Field of the Invention

The present invention relates generally to a personal computer with an external cache for file devices, and more particularly to a personal computer with an external cache for file devices in which a common cache memory is connected between the personal computer and a bus to which a CD-ROM drive, a hard disk drive, and the like are connected to allow the cache memory to be used commonly to a plurality of drives.

2. Description of Related Art

In recent years, personal computers have been propagated remarkably, and a hard disk drive and CD-ROM drive are generally incorporated into a personal computer as standard internal drives. As a connection interface, an IDE (Integrated Device Electronics) interface is mainstream, and improvement of the processing speeds of write and read processing as a performance of the personal computer has been required strongly.

However, in many kinds of file devices including a hard disk device, a transmission speed of information obtained by data reading and writing processes of a medium would be determined depending on the rotation speed and bit density of the medium, so that the transmission speed has a limited ability and a processing speed can not be improved in large amounts of data transmission as a system of the personal computer, resulting in a problem of prolonged data processing time.

As a solution to this problem, such countermeasures have been adopted that each of the file devices such as a hard disk drive and CD-ROM drive is equipped with an internal cache memory and also the capacity of the cache memory is made large. However, there is a problem such that it may cause the cost of each drive to be increased to integrate a large amount of cache memory into each drive, and as a result, the entire cost of the personal computer system may be increased.

### SUMMARY OF THE INVENTION

It is one object of the present invention to provide a personal computer with an external cache for file devices which realizes a cost effective and large capacity of cache memory by connecting a common cache memory between a personal computer and a bus to which file devices such as a hard disk drive and CD-ROM drive are connected to enable the cache memory to be used commonly to a plurality of drives.

According to one aspect of the present invention, a personal computer with an external cache for file devices is provided which comprises a personal computer, a cache adapter which is connected to the personal computer through at least one first bus, a cache memory which is connected to the cache adapter through a second bus, and at least one drive which is connected to the cache adapter through at least one third bus cached.

A read/write run command from the personal computer to the drive is issued from the personal computer to the cache adapter and cached at the cache adapter. A hard disk device or a removable file device can be used as the drive.

According to a second aspect of the present invention, a personal computer with an external cache for file devices is provided which comprises a personal computer, a cache adapter which is connected to the personal computer through a first and second bus, a cache memory which is connected to the cache adapter through a third bus, a first and second drive which are connected to the cache adapter through a fourth bus cached, and a third and fourth drive which are connected to the cache adapter through a fifth bus cached.

A read/write run command from the personal computer to each drive of the first, second, third, and fourth drives is issued from the personal computer to the cache adapter and cached in the cache adapter. Any combinations of a hard disk device and a removable file device can be used as the first, second, third, and fourth drives. As the removable file device, a CD-ROM device, optical disk device, magnetic tape device, DVD-ROM/RAM device, or floppy disk device can be used.

As a cache memory, a memory composed of modules standardized in the personal computer, for example, a SIMM (Single In-Line Memory Module) board with 72 or 168 pins, can be used.

### BRIEF DESCRIPTION OF THE DRAWINGS

The preferred embodiments of this invention will be described in detail, with reference to the following figures, wherein:

FIG. 1 is a constitution block diagram showing a personal computer with an external cache for file devices according to the present invention;

FIG. 2 is a flowchart showing a data read out operation of the personal computer with an external cache for file devices according to the present invention;

FIG. 3 is a flowchart showing a data write operation of the personal computer with an external cache for file devices according to the present invention; and

FIG. 4 is a flowchart showing a data write operation to another drive immediately after data writing of the personal computer with an external cache for file devices according to the present invention.

### DETAILED DESCRIPTION OF THE PREFERRED EMBODIMENTS

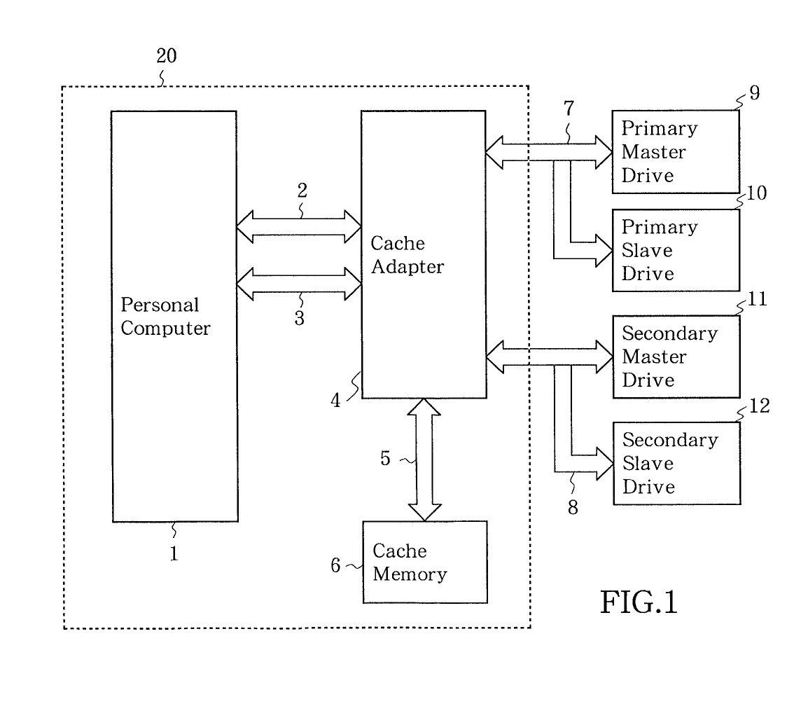

FIG. 1 is a constitution block diagram showing a personal computer with an external cache for file devices according to the present invention. The personal computer with an external cache for file devices comprises a personal computer enclosure 20 composed of a personal computer 1, a cache adapter 4 which is connected to the personal computer 1 through a primary IDE bus 2 and a secondary IDE bus 3, and a cache memory 6 which is connected to the cache adapter 4 through a local bus 5, a primary master drive 9 and a primary slave drive 10 which are connected to the cache adapter 4 through a cached primary IDE bus 7, and a secondary master drive 11 and a secondary slave drive 12 which are connected to the cache adapter 4 through a cached secondary IDE bus 8.

A read/write run command from the personal computer 1 to each of the primary master drive 9, primary slave drive 10, secondary master drive 11, and secondary slave drive 12 is issued by the personal computer 1 to the cache adapter 4 and cached by the cache adapter 4. However, the personal computer 1 has an additional command to the cache adapter 4, so that it can be controlled using software.

In addition, the primary master drive 9, primary slave drive 10, secondary master drive 11, and secondary slave drive 12 are composed of combinations of a hard disk device and a removable file device, and the removable file device is specifically composed of either of a CD-ROM device, optical disk device, magnetic tape device, DVD-ROM/RAM device, or floppy disk device.

Furthermore, the cache memory 6 is composed of a module standardized in the personal computer 1, and more specifically, of a SIMM (Single In-Line Memory Module) board with 72 or 168 pins.

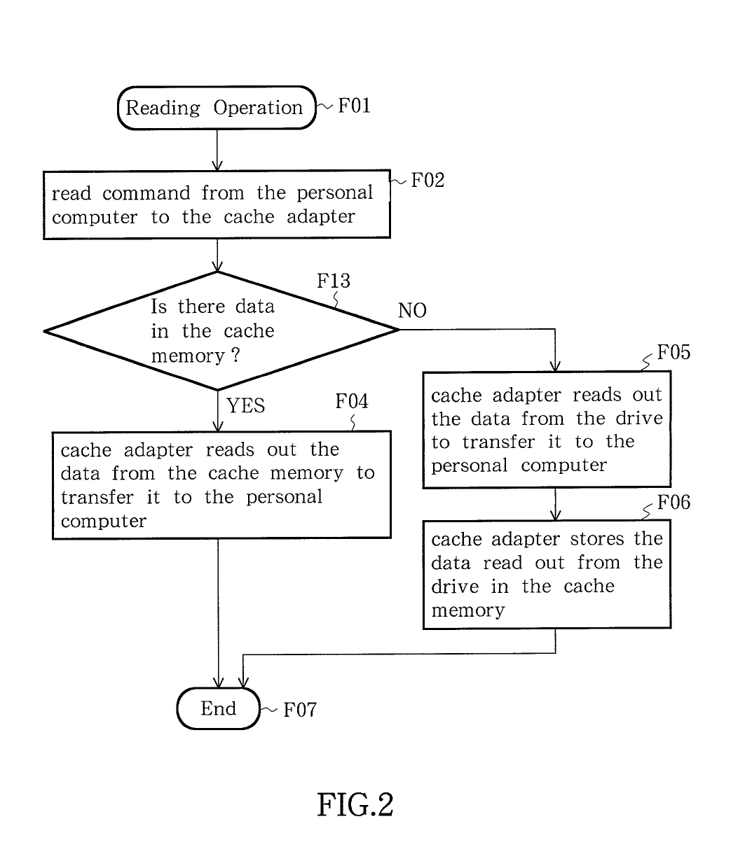

Next, the operation of the personal computer with an external cache for file devices according to the present invention will be described with reference to FIGS. 2, 3, and 4.

Firstly, the operation of the personal computer with an external cache for file devices according to the present invention when data is read out (F01) will be described in conjunction with the flowchart of FIG. 2.

Referring to FIG. 2, when a read command is issued from the personal computer 1 to the primary master drive 9 (F02), it is judged whether there is the data required in the cache memory 6 (F03). When there is the data in the cache memory 6, the cache adapter 4 reads out the data from the cache memory 6 (F04), and after the data being transferred to the personal computer 1, the read operation is completed (F07). However, when there is no data required in the cache memory 6, the cache adapter 4 reads out the data from the primary master drive 9 to transfer it to the personal computer 1 (F05). At this time, the cache adapter 4 causes the cache memory 6 to memorize the data read out from the primary master drive 9 (F06), and the read operation is completed (F07).

As a specific embodiment, if the entire dictionary of a kana-kanji conversion software has been memorized in the cache memory 6, the conversion speed can be improved. Additionally, if files frequently used have been memorized in the cache memory 6 when the personal computer 1 is started up, and the files are read out when required, the reading speed can be enhanced.

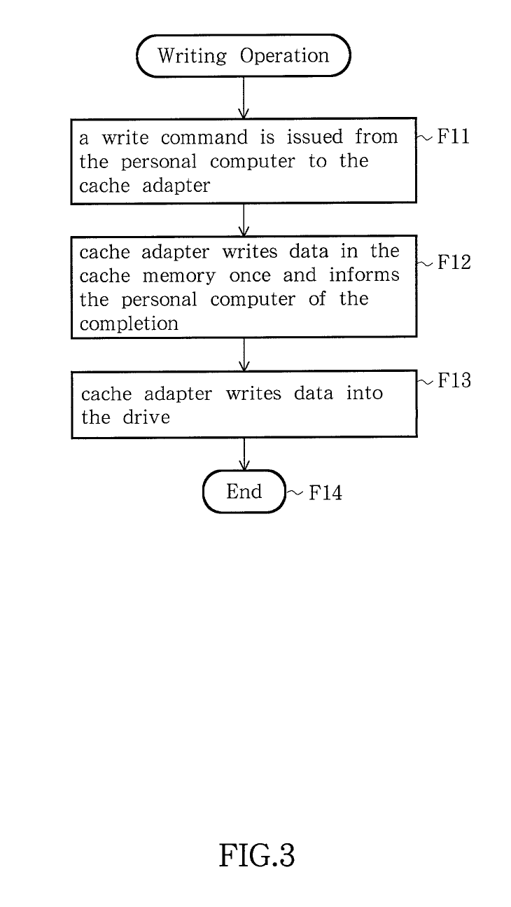

The operation of the personal computer with an external cache for file devices according to the present invention when data is written will then be described in conjunction with the flowchart of FIG. 3.

Referring to FIG. 3, when a write command is issued to the cache adapter 4 in order to write data from the personal computer 1 to the primary master drive 9 (F11), the cache adapter 4 which received the write command writes the data in the cache memory 6 once and informs the personal computer 1 of the completion of the writing operation (F12). At this time, the data write operation has been completed cosmetically, so that the personal computer 1 can perform another operation. After informing the personal computer 1 of the completion of the writing operation (F12), the cache adapter 4 writes the data to the primary master drive 9 (F13), then the data writing operation is completed (F14), so that the data writing operation of the cache adapter 4 to the primary master drive 9 (F13) is executed separately without affecting any operation of the personal computer 1, resulting in such an effect that the data write process time can be reduced cosmetically.

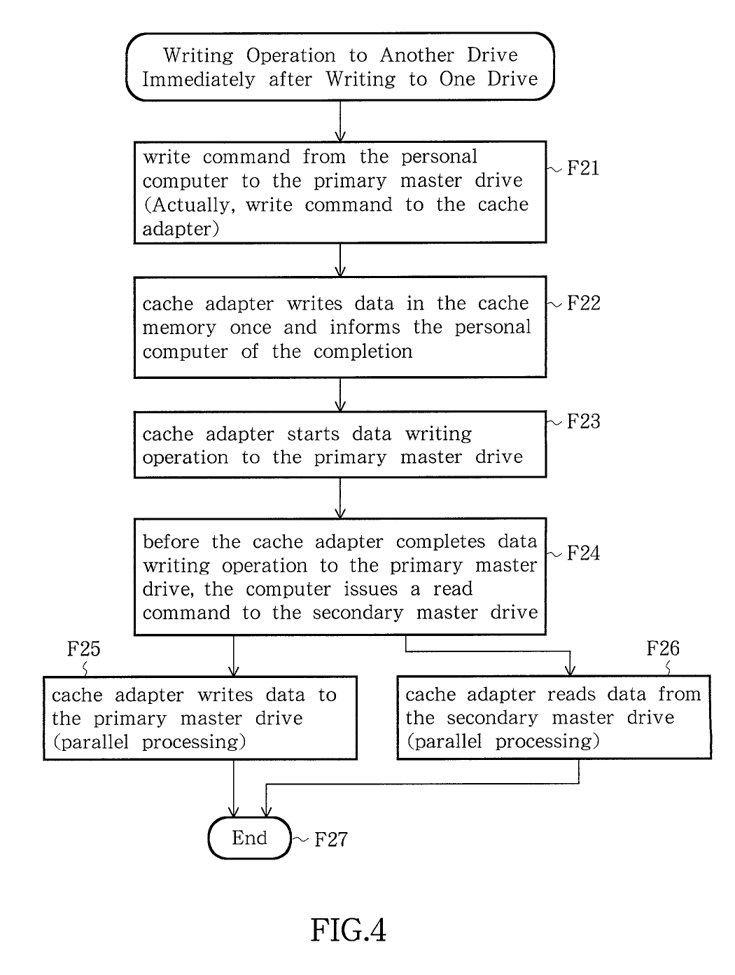

Further, the operation of the personal computer with an external cache for file devices according to the present invention when data is written to another drive immediately after the data has been written to one drive will be described in conjunction with the flowchart of FIG. 4.

Referring to FIG. 4, when a write command is issued to the cache adapter 4 in order to write data from the personal computer 1 to the primary master drive 9 (F21), the cache adapter 4 which received the write command writes the data in the cache memory 6 once and informs the personal computer 1 of the completion of the writing operation (F22). At this time, in a state when the data writing operation has been completed cosmetically, the cache adapter 4 starts the data writing operation to the primary master drive 9 (F23). If the personal computer 1 issues a read command to the secondary master drive 11 before the cache adapter 4 completes the data writing operation to the primary master drive 9 (F24), the cache adapter 4 starts parallel processing of the data writing process with the primary IDE bus 7 cached to the primary master drive 9 (F25) and of the data reading operation from the secondary IDE bus 8 cached to the secondary master drive 11 (F26), and then the writing process to another drive immediately after the data writing operation is completed (F27).

As was stated above, the present invention is provided with both effects in which the writing to or reading from another drive immediately after the writing to one drive can be performed.

As previously noted, the personal computer with an external cache common to file devices according to the present invention can realize a cost effective and large capacity of cache memory and has such an effect that can perform the data write/read process at high speed by connecting the common cache memory between the personal computer and the bus to which file devices such as hard disk and CD-ROM drives to enable the common cache memory to be used to a plurality of drives.

What is claimed is:

1. A personal computer with an external cache for file devices, comprising:
a personal computer;
a cache adapter which is connected to said personal computer through at least one first bus;
a cache memory which is connected to said cache adapter through a second bus, and
at least one drive which is connected to said cache adapter through at least one third bus cached.

2. The personal computer with an external cache for file devices according to claim 1, wherein a read/write run command from said personal computer to said drive is issued from said personal computer to said cache adapter and cached at said cache adapter.

3. The personal computer with an external cache for file devices according to claim 1, wherein said drive comprises a hard disk drive or removable file device.

4. A personal computer with an external cache for file devices, comprising:
a personal computer;
a cache adapter which is connected to said personal computer through a first and second bus;
a cache memory which is connected to said cache adapter through a third bus;
a first and second drive which are connected to said cache adapter through a fourth bus cached; and
a third and fourth drive which are connected to said cache adapter through a fifth bus cached.

5. The personal computer with an external cache for file devices according to claim 4, wherein a read/write run command from said personal computer to each drive of said first, second, third, and fourth drives is issued from said personal computer to said cache adapter and cached in said cache adapter.

6. The personal computer with an external cache for file devices according to claim 4, wherein said first, second, third, and fourth drives are composed of any combinations of a hard disk device and a removable file device.

7. The personal computer with an external cache for file devices according to claim 6, wherein said removable file device is either of a CD-ROM device, optical disk device, magnetic tape device, DVD-ROM/RAM device, or floppy disk device.

8. The personal computer with an external cache for file devices according to claim 1, wherein said cache memory is composed of modules standardized in said personal computer.

9. The personal computer with an external cache for file devices according to claim 8, wherein said module standardized in said personal computer is composed of a SIMM (Single In-Line Memory Module) board with 72 or 168 pins.
